(19) United States
(12) Patent Application Publication
(10) Pub. No.: US 2011/0266770 A1
(43) Pub. Date: Nov. 3, 2011

(54) TRANSMISSION SYSTEM FOR CYCLE HAVING TWO IDENTICAL WHEELS

(76) Inventor: Sylvio Beraka, Bordeaux (FR)

(21) Appl. No.: 13/003,556

(22) PCT Filed: Jul. 9, 2009
(86) PCT No.: PCT/FR2009/000853

§ 371 Date: Mar. 21, 2011

(30) Foreign Application Priority Data
Jul. 9, 2008 (FR) 0803910

(51) Int. Cl. B62K 15/00; B62M 9/06

(52) U.S. Cl. 280/287; 474/148

(57) ABSTRACT

The present invention relates to a transmission system for a two-wheeled cycle of the type comprising at least one sprocket (1) attached to the rear wheel hub (2) and rotatably mounted around an axis (x); at least one chainring (3) secured to the frame of the cycle and rotatably mounted around a second axis (y) parallel to the axis (x); a crankset composed of two pedals (7, 8) rotatable around a third axis (z) parallel to the axes (x, y) and located inside the rear wheel; and a main transmission element (6) drivable by actuating the crankset and passing through said sprocket (1) and also passing through, or controlled by, said chainring (3). Such a system is characterized in that the axis (z) is at a distance from the axis (x) and the axis (y), in that first transmission means (9) are provided between the pedal (7) and at least one of the axes (x, y), and in that second transmission means (13) are provided between the other pedal (8) and at least one of the axes (x, y), said transmission means (9, 13) being arranged so as to respectively transmit the rotation of each pedal (7, 8) to at least one of the axes (x, y), the rotation of which generates the actuation of the main transmission element (6) and the synchronization of the pedals (7, 8).

The present invention relates to a transmission system for a cycle with two identical wheels, each having a standard diameter of 22 to 26 inches, said cycle being of the type comprising at least one sprocket attached to the rear wheel hub, said sprocket having a first axis of rotation, and at least one chainring secured to the frame of the cycle; said chainring has a second axis of rotation parallel to said first axis, at a distance from said first axis, a crankset, and a main transmission element driven by said crankset and passing through said at least one sprocket and through said at least one chainring. The invention also relates to a cycle, hereinafter called a bicycle, equipped with such a transmission system.

The last few years have seen, particularly in urban environments, an ever-increasing demand for a simple and practical means of transportation. There has thus been a big growth in urban bicycle travel as an alternative to the use of public transportation and cars. The successful implementation of bike sharing systems by city governments in various big cities and the creation of bike lane networks have contributed to the expansion of this simple, economical, and environmentally friendly mode of transportation.

For this reason, the number of bicycles in cities has been observed to be constantly increasing. Users in urban environments generally purchase city—i.e., standard—bikes, which are comfortable for them to use. Users thus choose bicycles with large wheel diameters, usually 22 to 26 inches, or 55.88 to 66.04 cm, which provide them with greater riding comfort on long distance in-town trips.

Although such so-called standard bikes do provide a comfortable ride in town, they nonetheless have various drawbacks. For example, such bikes are relatively heavy and bulky. Also, users who do not have garage or storage area for bicycles in their homes and would have difficulty carrying them up to their apartments are forced to leave their bikes on the street, exposing them to potential damage such as stolen parts, if not the theft of the bike itself.

To overcome this drawback, folding bikes have been proposed which make it easier for the user to store his bike in his apartment or transport it by placing it in the trunk of his car, without the need for an exterior structure such as a roof rack or bicycle carrier. However, the proposed models have wheels of smaller diameter, generally 16 inches in diameter, resulting in a roll inertia that is tiring and uncomfortable for daily use. For this reason, people who use a bike on a daily basis do not want folding or compact bikes due to the lack of comfort and low performance.

It is understood, moreover, that it is impossible to reduce the distance between the two wheels of a standard cycle with a standard transmission, since such a reduction in the length of the cycle would make any rotation of the handlebars impossible.

A transmission system for a standard two-wheel cycle generally comprises at least one sprocket attached to the rear wheel hub, as well as a chainring secured to the frame of the cycle and to which is attached a crankset, while a transmission chain passing through said at least one sprocket and through said chainring is driven by the crankset, which is generally mounted on the axis of rotation of the chainring. Also, in a standard structure, the front wheel and the rear wheel of the cycle are mounted on the frame, which also supports the saddle for the cyclist, and positioned between the two wheels, substantially in a vertical line with the saddle, is the assembly constituted by the chainring and the crankset.

Bicycles have since been proposed in which the transmission system between the crankset and the rear wheel hub has been modified, particularly with regard to the location of said crankset, in order to improve the bicycle's performance.

In a standard transmission system as described above, the transmission chain is exposed to the air, and therefore rusts relatively quickly. What is more, this chain often comes off, and this type of transmission system is not always easy to repair and/or maintain.

It has also been proposed to modify the transmission systems, particularly by placing the crankset directly on the rear wheel hub. Thus, U.S. Pat. No. 5,228,710 proposes a transmission system equipped with a crankset that is located on the rear wheel hub and that also comprises a plurality of gears on one end of the rear wheel hub.

U.S. Pat. No. 5,403,027 proposes a bicycle transmission positioned not horizontally but vertically; the crankset in this case is placed on the rear wheel hub, and each of two chains connects one side of the crankset to a device located on the rear fork of the bicycle, below the saddle.

EP 1,398,257 proposes a bicycle that makes it possible to obtain improved speed performance as a result of a novel, semi-prone posture of the cyclist. To this end, the frame, the transmission system, the handlebars and the saddle have all been modified. In particular, the cranksets and the transmission system are composed of the rear wheel hub and two separate assemblies comprising a left pedal, a right pedal, a left transmission chain, and a transmission chain, these two chains being connected to a left drive sprocket and a right drive sprocket, respectively, and to the rear wheel hub.

Similarly, EP 0,314,601 proposes a bicycle wherein all of the power is produced on the axis of the rear hub, which requires less effort on the part of the cyclist. Thus, the transmission system is composed of two toothed chainrings which are placed on either side of two fixed discs that form part of the frame of the bicycle, the chainrings being geometrically, though not physically, aligned. Two chains on two sprockets synchronize the movement of the pedals, which are independent. A floating or fixed sprocket is placed on the rear wheel hub and it synchronizes the pedals.

EP 0,154,118 proposes a bicycle which makes it possible to improve the man-machine aerodynamics while reducing the weight of the bicycle. This bicycle comprises a frame, a front wheel, a rear wheel, a pedal propulsion unit, a saddle and a set of handlebars. The diameter of the front wheel is smaller than the diameter of the rear wheel. The propulsion unit comprises a pair of pedals attached to a shaft rotatably housed in the rear wheel hub. The transmission comprises a first sprocket fitted on the shaft of the crankset, a first chain linking said first sprocket to a second sprocket held on a pin which itself holds a plate attached to the tube of the bicycle frame, and a third sprocket attached to the pin which transmits the movement by means of a second chain to a fourth sprocket attached to the rear wheel hub.

Bicycles of this type are intended to improve the man-machine aerodynamics by offering, in particular, a semi-prone position of the cyclist. While such bicycles are particularly well adapted to bicycle racing, they are, on the other hand, absolutely unsuitable for use in an urban environment where the performance sought by users has more to do with comfort and ride quality than with speed.

In particular, bicycles of the aforementioned type are still somewhat bulky, if not even bulkier than a conventional bicycle, and they therefore do not have the desired compactness for a bicycle that could be qualified as a “city” bike.

JP 2005/119498 describes a compact bicycle of reduced weight. The bicycle has pedals set back near the rear wheel, and the transmission is provided by two transmission belts placed on either side of the rear wheel, each linking the shaft supporting the pedal to the rear wheel hub. A set of three intermeshing gear wheels transmits the rotation of the rear wheel hub to a disc secured to the rear wheel, coaxial with the latter. This device is clearly very noisy because of the gear changes. Such a bicycle also has a front wheel of small size to keep it compact. Thus, such a bicycle cannot be compared to a standard-type bicycle equipped with two front and rear wheels of standard dimensions.

Consequently, there is still a need to propose a standard-type bicycle, i.e., one that has wheels with a large diameter of 22 to 26 inches, that offers excellent rolling performance and that simultaneously offers a degree of compactness that standard-type bicycles do not currently make possible.

The object of the present invention is to overcome these drawbacks by proposing a compact bicycle which, in structure, remains nearly identical to a standard bicycle, meaning that this compact bicycle has the characteristics of an ordinary bicycle—i.e. large wheels of 22 to 26 inches in diameter, which guarantee comfortable rolling performance in an urban environment—the bicycle according to the invention being noteworthy in that its transmission, on the other hand, is novel and is designed to make it possible to obtain a bicycle structure having dimensions—particularly a more reduced overall length—that make it more compact than a standard road bike. More precisely, the length of the proposed bicycle according to the invention is reduced by more than half a wheel and is thus equal to the length of a standard bicycle equipped with two small wheels of 14 inches in diameter.

Thus, the main object of the invention is to propose a transmission system for a two-wheeled cycle that is adapted so as to reduce the dimensions of the bicycle frame, particularly by reducing the distance between the two wheels, while providing a standard seating position for the cyclist. The distance between the two standard—for example 26-inch—wheels is reduced in this case by 90%.

As a result of this reduced wheelbase, the steering angle of the bicycle according to the invention is substantially improved and more efficient, and thus said bicycle has greater stability on curves and much better handling for urban riding.

The first subject of the invention is therefore a transmission system for a cycle with two identical wheels, each having a standard diameter of 22 to 26 inches, said cycle being of the type comprising:

at least one sprocket attached to the rear wheel hub, said hub being rotatably mounted around a first axis called the hub axis,

at least one chainring secured to the frame of the cycle, said chainring being rotatably mounted around a second axis called the chainring axis, parallel to the hub axis,

a crankset composed of two pedals, mounted at a distance from each other and so as to rotate around a third axis called the crankset axis, which runs parallel to the first and second axes, the crankset axis being located inside the rear wheel, and

a main transmission element drivable by actuating the crankset and passing through said at least one sprocket attached to the rear wheel hub, and also passing through, or controlled by, said at least one chainring, characterized in that the crankset axis is at a distance from both the hub axis and the chainring axis, in that first transmission means are provided between one of the pedals and at least one of the first and second axes, and in that second transmission means are provided between the other pedal and at least one of the first and second axes, said first and second transmission means being arranged so as to respectively transmit the rotation of each pedal around the crankset axis to at least one of the first and second axes, the rotation of which generates both the actuation of the main transmission element passing through said at least one sprocket and said at least one chainring and the synchronization of the pedals.

Thus, advantageously, the synchronization of the pedals and their action on the main transmission element are performed by separate transmission means via either or both of the first and second axes of rotation, so that these pedals can be positioned at a distance from each other on said third axis corresponding to the propulsion axis; this axis may also be partly virtual, so that it is possible to position the pedals on either side of the rear wheel, preferably substantially between the rear wheel hub and the chainring; even more preferably, the pedals are positioned so that the rotating movement of the pedals does not go past the rear wheel.

Thus, the transmission system according to the invention can be advantageously positioned in the vicinity of the rear wheel of a bicycle so that the distance between the rear wheel and the front wheel can be advantageously reduced, thus offering, for wheels of standard dimensions, a bicycle that is much more compact and less bulky since it is less long, and offering its user the ability to pedal while maintaining control of the steering angle of the front wheel.

According to a first embodiment, the transmission system according to the invention is characterized in that the first transmission means are provided between the pedal and the second axis and are also associated with a sprocket mounted so as to rotate around the third axis during the rotation of the pedal and with a sprocket rotatably mounted around the second axis so as to cause the second axis carrying said chainring to rotate along with it, and consequently, to drive the main transmission element passing through said at least one sprocket and said at least one chainring, and in that the second transmission means associated with the other pedal are also associated with a sprocket mounted so as to rotate around the third axis during the rotation of the pedal and with a sprocket rotatably mounted around the second axis so that the pedals are rotationally synchronized and so that the actuation of the pedal also actuates the main transmission element.

According to a second embodiment, the first transmission means are provided between the pedal and the second axis and are also associated with a sprocket mounted so as to rotate around the third axis during the rotation of the pedal and with a sprocket of the chainring rotatably mounted around the second axis so as to cause the second axis carrying said chainring to rotate along with it, the sprocket causing to rotate along with it a coaxial sprocket of larger diameter on which is mounted the main transmission element passing through said at least one sprocket, and in that the second transmission means associated with the other pedal are also associated with a sprocket mounted so as to rotate around the third axis during the rotation of the pedal, and with a sprocket rotatably mounted around the second axis so that the pedals are rotationally synchronized and so that the actuation of the pedal, via the first and second transmission means, also results in the actuation of the main transmission element.

According to a third embodiment, the first transmission means are provided between the pedal and the second axis and are also associated with a sprocket mounted so as to rotate around the third axis during the rotation of the pedal, and with the sprocket of the chainring rotatably mounted around the second axis so as to cause the second axis to rotate along with it, and consequently, to drive the main transmission element passing through said at least one sprocket and through said at least one chainring, and in that the second transmission means associated with the other pedal are also associated with a sprocket mounted so as to rotate around the third axis during the rotation of the pedal, and with a sprocket rotatably mounted around the second axis so that the pedals are rotationally synchronized and so that the actuation of the pedal also results in the actuation of the main transmission element.

In a first variant which can be common to all three aforementioned embodiments, the three axes, at a distance from each other, are substantially disposed in a single plane formed by two left and right parts of the rear fork of the cycle, each of said fork parts extending from the ends of the axle part constituting the first axis to the ends of the axle part constituting the second axis.

In a second variant which can also be common to all three aforementioned embodiments, two stays extend parallel to each other from the ends of the axle part constituting the first axis to the ends of the axle part constituting the second axis, each stay being provided with a respective stay running transverse to each stay, preferably perpendicular to said stays, and at the end of which the free end of a crank supporting a pedal is rotatably mounted around the third axis.

Quite advantageously, the transmission system for a cycle with two identical standard wheels according to the invention also includes a tension sprocket rotatably mounted around a fourth axis parallel to the first three that makes it possible to adjust the tension of the main transmission element.

In the first embodiment, the diameter of the chainring is preferably larger than that of the other sprockets used.

In the third embodiment, the two sprockets rotatably mounted around the third axis are preferably of larger diameter than the sprocket attached to the hub and are also of larger diameter than the sprockets of the chainring.

Lastly, in the second embodiment, the sprocket coaxial with the sprocket is preferably of larger diameter than the sprocket of the chainring and of larger diameter than the sprocket attached to the hub.

The main transmission element and the first and second transmission means will advantageously be constituted by chains or notched belts or the like, for example Kevlar belts, and the teeth of the sprockets will be arranged accordingly.

Quite clearly, the second subject of the invention is a two-wheeled cycle of the type comprising a frame to which are attached wheels of at least 22 inches in diameter, a set of handlebars and a saddle, said cycle being noteworthy in that it includes a transmission system like those claimed above.

Advantageously, the frame of such a cycle will be made to fold in half in such a way that the transmission system does not interfere with this folding capability. On the contrary, while it is normally impossible to wheel a cycle that has been folded in half, the cycle according to the invention can be folded so that the wheels are in perfect symmetry and can then be handled like a rolling suitcase.

The invention will now be described in greater detail in reference to the attached drawings, in which:

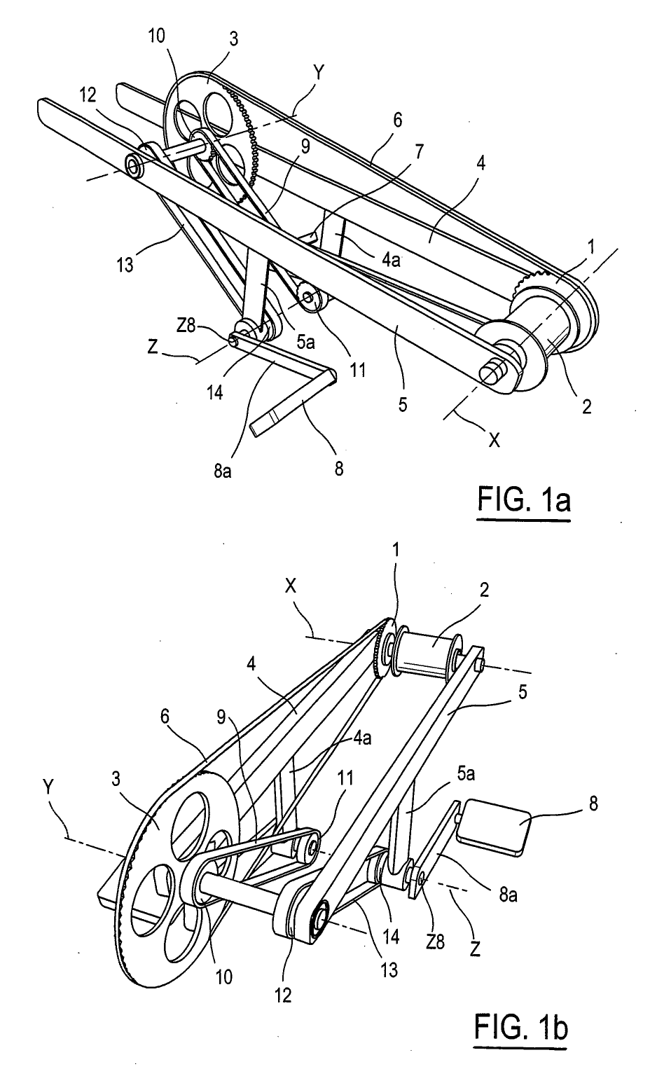

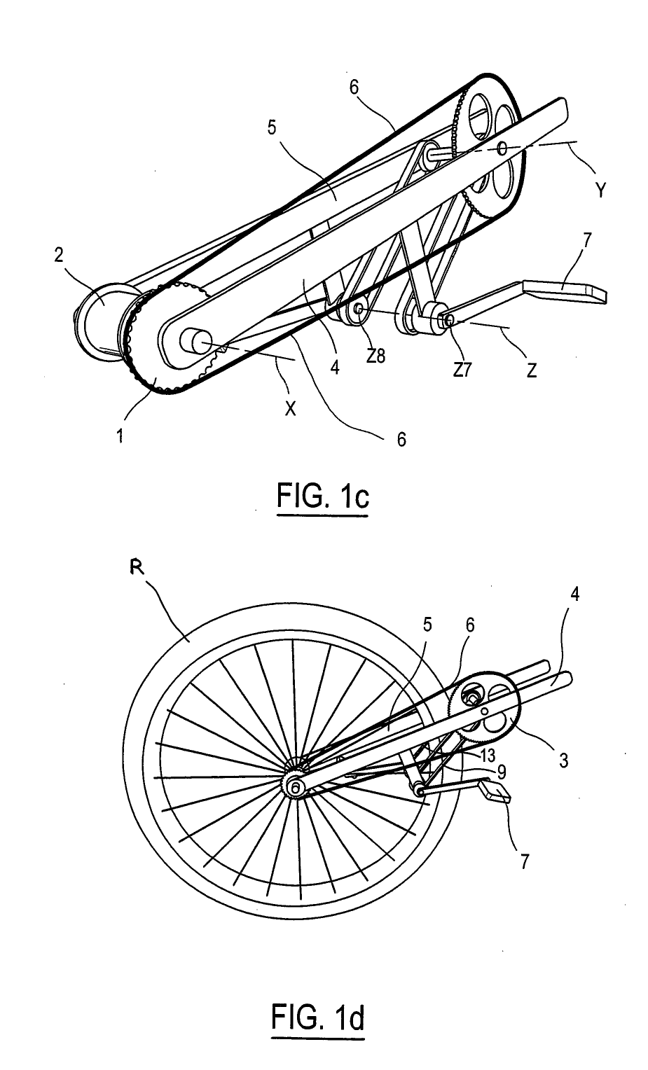

FIG. 1a represents a simplified left rear perspective view of a transmission system according to a first embodiment of the invention;

FIG. 1b represents a front perspective view of the system of FIG. 1a;

FIG. 1c represents a right rear perspective view of a system according to FIG. 1a;

FIG. 1d represents a side perspective view of a transmission system according to FIG. I a mounted on a rear bicycle wheel;

FIG. 1e is a side perspective view of the system of FIGS. 1a through 1d, modified in that the hub axis, the chainring axis and the crankset axis are disposed substantially in a straight line constituted by a part of the rear fork of the cycle;

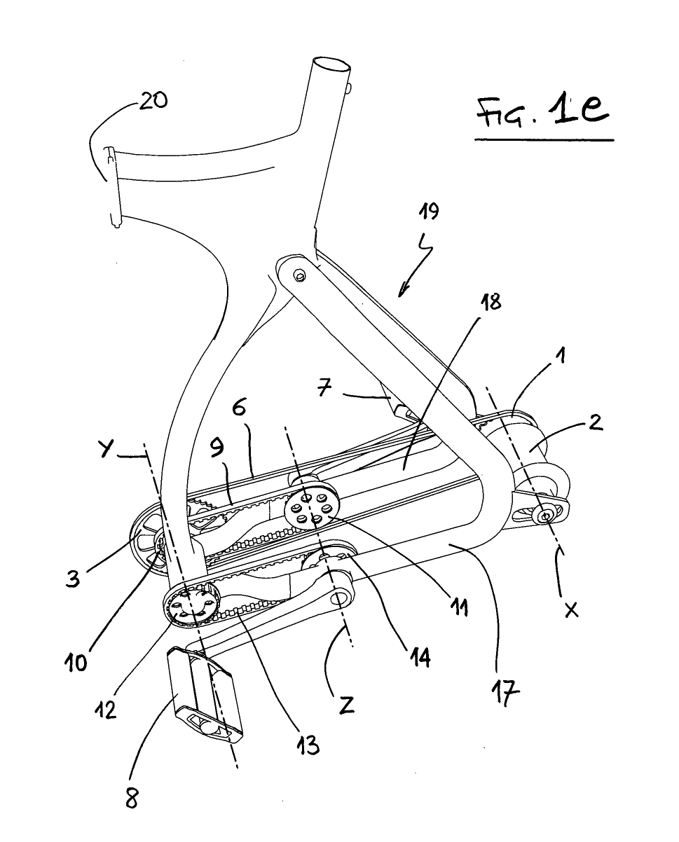

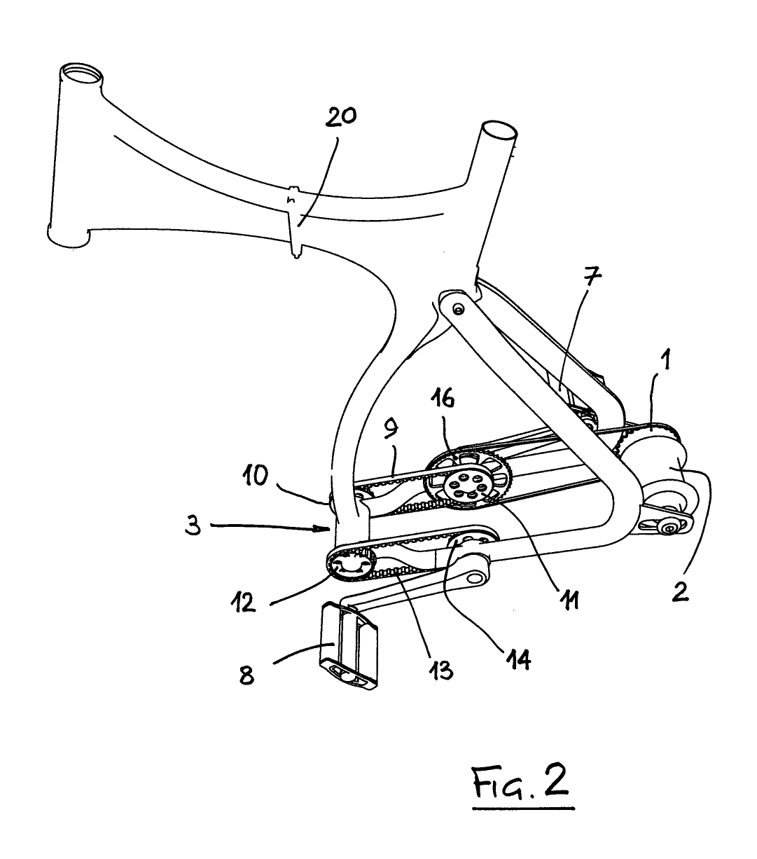

FIG. 2 represents a side perspective view of a transmission system according to a second embodiment of the invention;

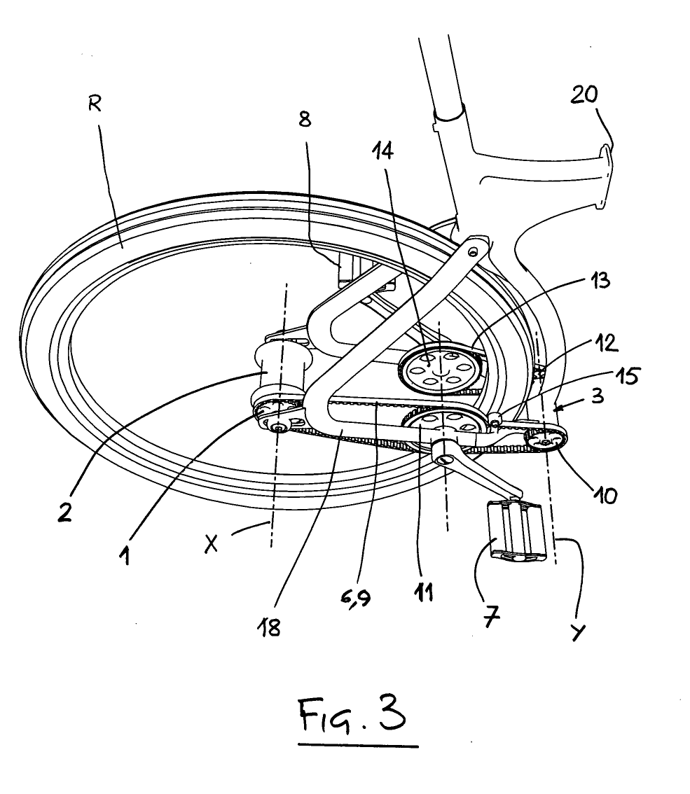

FIG. 3 represents a side perspective view of a transmission system according to a third embodiment of the invention;

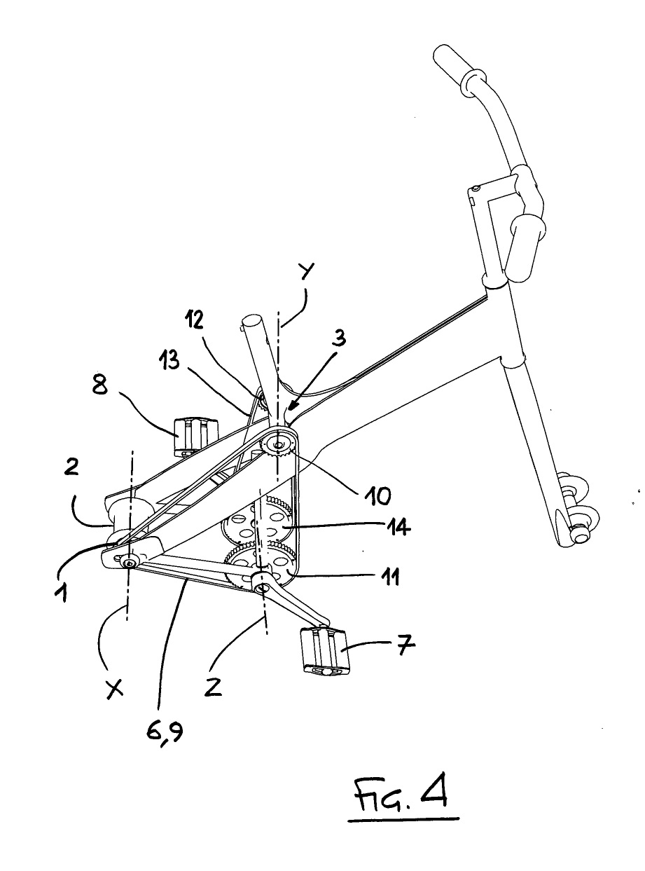

FIG. 4 is a perspective view of a variant of the third embodiment of the invention, in which variant the three axes are not coplanar, the chainring axis being moved to the level of the apex of the rear fork of the cycle.

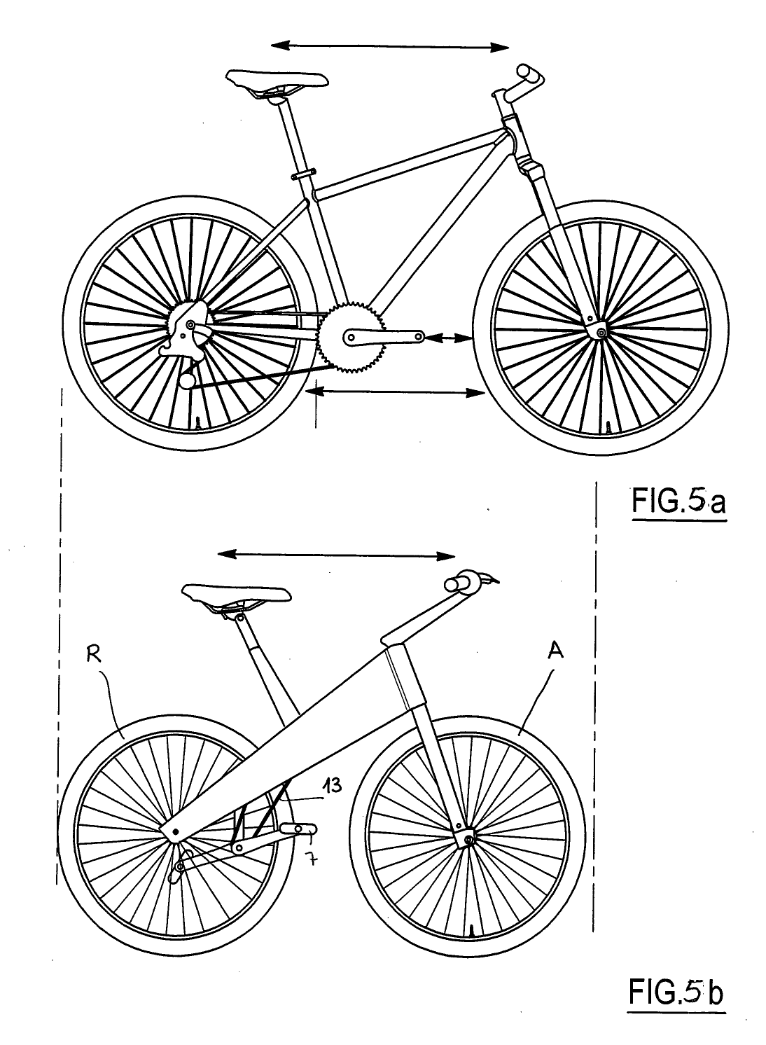

FIGS. 5a and 5b respectively represent a bicycle equipped with a transmission system according to the prior art and a bicycle equipped with a transmission system according to the invention.

The transmission system for a two-wheeled cycle according to the invention comprises, in the embodiment shown in FIG. 1a, a sprocket 1 mounted on the hub 2 of the rear wheel, said hub 2 being rotatable around a first axis x, also corresponding to the axis of rotation of the rear wheel.

The transmission system also includes a chainring 3 rotatable around a second axis y corresponding to a gearing axis. This axis y is parallel to the hub axis x. Two stays 4, 5 of the rear fork of the cycle extend parallel to each other from the ends of the axle part constituting the hub axis x to the ends of the axle part Y constituting the chainring axis y.

A transmission element such as a transmission chain, a notched transmission belt 6, for example a traditional Kevlar belt or any other similar appropriate element passes through said sprocket 1 and through said chainring 3.

The crankset is composed in standard fashion of two pedals 7, 8 and two cranks 7a, 8a. The free end of each crank 7a, 8a is rotatably mounted around a third axis z, at the end of a stay 4a, 5a, respectively running transverse to each stay 4, 5, preferably perpendicular to said stays 4, 5. Each crank 7a, 8a has, at its free end, an aperture in which is seated, fixed in rotation with the crank, an axle piece or part Z7, Z8. This axle piece Z7, Z8 is freely rotatably mounted on the end of the respective stay 4a, 5a.

Thus, the cranks 7a, 8a of the pedals 7, 8 are mounted apart from each other at a distance corresponding to the width of a rear wheel, but so as to rotate around the same third axis z, in this case virtual, embodied only by the axle pieces Z7, Z8. As may be seen in FIG. 1d, it is therefore possible to put the pedals 7, 8 on either side of the rear wheel R.

This virtual axis z runs parallel to the axis x of the rear wheel and the axis y of the chainring 3 and it is positioned between these two axes x, y substantially below them.

First transmission means are provided between one 7 of the pedals 7, 8 and one of the first and second axes, in the example shown the second axis y, so that during the rotation of said pedal 7 around the third axis z, the axle part Y also supporting the chainring 3 is rotated, which results in the actuation of the main transmission element 6 passing through said sprocket 1 attached to the hub 2 of the rear wheel R and through said chainring 3.

Thus, the pedal 7 is provided on the inside with a sprocket 11 fixedly mounted to the axle piece Z₇ so as to thus rotate around the axis z during the rotation of the pedal 7, this sprocket 11 being linked to the axis y of the chainring 3 by means of a transmission element 9 such as a notched belt, which cooperates with said sprocket 11 and with a sprocket 10 fixedly mounted on the axle part Y, coaxial to the chainring 3. The chainring 3 therefore preferably sits off-center on the axis y on the same side as the pedal 7, the sprocket 1 likewise being mounted on the end of the hub 2 on the side of the pedal next to the chainring 3.

Thus, when the pedal 7 is rotated around the axis z, which is thus the propulsion axis, the sprocket 11 drives the transmission belt 9, which drives the sprocket 10, consequently driving the chainring 3, which in turn drives the sprocket 1 attached to the hub 2 of the rear wheel and thus transmits the propulsion to the rear wheel axis x via the gearing axis y.

In this structure, the diameter of the chainring 3 is consequently greater than that of each of the sprockets 1, 10 and 11.

Second transmission means are provided between the axis y and the other pedal 8, so that said pedals 7 and 8 are rotationally synchronized and so that the actuation of the pedal 8 also results in the actuation of the main transmission element 6. Thus, on the axle part Y, on the opposite end from the chainring 3, is provided a sprocket 12 that cooperates with a transmission element such as a notched belt 13, which also passes over a sprocket 14 fixedly mounted to the axle piece Z8, rotatable around the axis z and supporting the end of the crank 8a of the other pedal 8 so as to synchronize said pedal 8 with the pedal 7.

Thus, a transmission system is obtained which can be located primarily in the vicinity of the rear wheel R of a bicycle, making it possible, in particular, to substantially reduce—i.e., by approximately 90%—the distance between the front wheel A and the rear wheel R without interfering with the steering angle of this front wheel A. The axis y in this case being embodied by the axle part Y, the chainring 3 is positioned outside the rear wheel R, in front of the latter.

In the aforementioned structure, the three axes x, y and z at a distance from each other are not coplanar.

In the variant of the aforementioned first embodiment represented in FIG. 1e, the axes x, y and z are substantially disposed in a single plane formed by two left 17 and right 18 parts of the rear fork 19 of the cycle, each of said fork parts 17, 18 extending substantially from the ends of the axle part constituting the first axis x to the ends of the axle part constituting the second axis y.

In the second embodiment represented in FIG. 2, the same references are used for the components and elements that are similar to those of the first embodiment, with the notable exception that in this case, chainring 3 is generally understood to indicate the front part of the transmission system that is secured to the frame of the cycle.

In the structure of FIG. 2, the first transmission means 9 are provided between the pedal 7 and the second axis y, and accordingly, they are also associated with a sprocket 11 mounted so as to rotate around the third axis z during the rotation of the pedal 7 and with a sprocket 10 of the chainring 3 rotatably mounted around the second axis y. The rotation of the pedal 7 thus rotates the second axis y carrying the chainring 3 by means of the transmission means 9 and the sprockets 10 and 11. Simultaneously, the sprocket 11 rotates along with it a coaxial sprocket 16 of larger diameter, on which is mounted the main transmission element 6 which also passes through the sprocket 1. In this second embodiment, the second transmission means 13 associated with the other pedal 8 are also associated with a sprocket 14, mounted so as to rotate around the third axis z during the rotation of the pedal 8, and with a sprocket 12 rotatably mounted around the second axis y. As a result of this structure, the pedals 7, 8 are rotationally synchronized and the actuation of the pedal 8 via the first 9 and second 13 transmission means, also results in the actuation of the main transmission element 6.

Advantageously, the sprocket 16 coaxial with the sprocket 11 in this case is of larger diameter than the sprocket 10 of the chainring 3 and also of larger diameter than the sprocket 1 attached to the hub 2.

In the third embodiment represented in FIG. 3, the first transmission means 9 are provided between the pedal 7 and the second axis y and are also associated with a sprocket 11, mounted so as to rotate around the third axis z during the rotation of the pedal 7, and with the sprocket 10 of the chainring 3 rotatably mounted around the second axis y so as to rotate the second axis y along with it. The first transmission means 9 in this case are the same as the main transmission means 6, and they therefore also pass through the sprocket 1 of the hub 2. The second transmission means 13 that are associated with the other pedal 8 are also associated with a sprocket 14, mounted so as to rotate around the third axis z during the rotation of the pedal 8, and with a sprocket 12 rotatably mounted around the second axis y. Thus, in this structure as well, the pedals 7, 8 are rotationally synchronized and the actuation of the pedal 8 also results in the actuation of the main transmission element 6.

Advantageously, in this third structure, the two sprockets 11, 14 rotatably mounted around the third axis z are of larger diameter than the sprocket 1 attached to the hub 2 and are also of larger diameter than the sprockets 10, 12 of the chainring 3.

Also noted in this third embodiment is the presence of a tension sprocket 15 secured to the branch 18 of the fork 19, said sprocket 15 being rotatably mounted around a fourth axis parallel to the axes x, y and z and being capable of adjusting the tension of the main transmission element 6, for example by means of an adjustable spring disposed between the sprocket 15 and the branch 18 of the fork.

In the variant of the third embodiment shown in FIG. 4, in this instance the chainring 3 is provided at the base of the fork 19 and thus, in this variant, the three axes x, y and z are not coplanar.

In all of the above structures, the main transmission element 6 as well as the first 9 and second 13 transmission means are constituted by chains or notched belts or the like, for example Kevlar belts. It is understood that the teeth of the sprockets 1, 3, 10, 11, 12, 14 and 16 are arranged so as to correspond with such chains or such belts.

The frame of the cycle equipped with one of the transmission systems described above is advantageously made to fold in half, as indicated by the reference 20.

It should be noted that one of the consequences of the proposed structures according to the present invention is that, due to the offset of the crankset axis, the saddle-crankset alignment is vertical or nearly vertical. Thus, the user of the cycle according to the invention is seated on the saddle in an upright position exactly like that of the cycles in circulation in the Netherlands, which are known for their great comfort.

Such a seated position allows the cyclist to increase his safe field of vision and to maintain the natural curvature of the spinal column, thus preventing backaches. In addition, the cyclist will be more visible to other road users, resulting in a further improvement in safety.

It is understood that the invention is not limited to the exemplary embodiments shown but covers all of the embodiments defined in the dependent claims.

1. Transmission system for a cycle with two identical wheels, each having a standard diameter of 22 to 26 inches, said cycle being of the type comprising:
at least one sprocket (1) attached to the hub (2) of the rear wheel, said hub (2) being rotatably mounted around a first axis (x) called the hub axis,
at least one chainring (3) secured to the frame of the cycle, said chainring being rotatably mounted around a second axis (y) called the chainring axis, parallel to the hub axis (x),
a crankset composed of two pedals (7, 8), mounted at a distance from each other and so as to rotate around a third axis (z) called the crankset axis, which runs parallel to the first and second axes (x, y), the crankset axis (z) being located inside the rear wheel, and
a main transmission element (6) drivable by actuating the crankset and passing through said at least one sprocket (1) attached to the hub (2) of the rear wheel, and also passing through, or controlled by, said at least one chainring (3), characterized in that the crankset axis (z) is at a distance from both the hub axis (x) and the chainring axis (y), in that first transmission means (9) are provided between one (7) of the pedals (7, 8) and at least one of the first and second axes (x, y), and in that second transmission means (13) are provided between the other pedal (8) and at least one of the first and second axes (x, y), said first and second transmission means being arranged so as to respectively transmit the rotation of each pedal (7, 8) around the crankset axis (z) to at least one (x, y) of the first and second axes, the rotation of which generates both the actuation of the main transmission element (6) passing through said at least one sprocket (1) and said at least one chainring (3) and the synchronization of the pedals (7, 8).

2. Transmission system for a cycle with two identical standard wheels according to claim 1, characterized in that the first transmission means (9) are provided between the pedal (7) and the second axis (y) and are also associated with a sprocket (11) mounted so as to rotate around the third axis (z) during the rotation of the pedal (7) and with a sprocket (10) rotatably mounted around the second axis (y) so as to cause the second axis (y) carrying said chainring (3) to rotate along with it, and consequently, to drive the main transmission element (6) passing through said at least one sprocket (1) and said at least one chainring (3), and in that the second transmission means (13) associated with the other pedal (8) are also associated with a sprocket (14) mounted so as to rotate around the third axis (z) during the rotation of the pedal (8) and with a sprocket (12) rotatably mounted around the second axis (y) so that the pedals (7, 8) are rotationally synchronized and so that the actuation of the pedal (8) also actuates the main transmission element (6).

3. Transmission system for a cycle with two identical standard wheels according to claim 1, characterized in that the first transmission means (9) are provided between the pedal (7) and the second axis (y) and are also associated with a sprocket (11) mounted so as to rotate around the third axis (z) during the rotation of the pedal (7) and with a sprocket (10) of the chainring (3) rotatably mounted around the second axis (y) so as to cause the second axis (y) carrying said chainring (3) to rotate along with it, the sprocket (11) causing to rotate along with it a coaxial sprocket (16) of larger diameter on which is mounted the main transmission element (6) passing through said at least one sprocket (1), and in that the second transmission means (13) associated with the other pedal (8) are also associated with a sprocket (14) mounted so as to rotate around the third axis (z) during the rotation of the pedal (8), and with a sprocket (12) rotatably mounted around the second axis (y) so that the pedals (7, 8) are rotationally synchronized and so that the actuation of the pedal (8), via the first and second transmission means, also results in the actuation of the main transmission element (6).

4. Transmission system for a cycle with two identical standard wheels according to claim 1, characterized in that the first transmission means (9) are provided between the pedal (7) and the second axis (y) and are also associated with a sprocket (11) mounted so as to rotate around the third axis (z) during the rotation of the pedal (7), and with the sprocket (10) of the chainring (3) rotatably mounted around the second axis (y) so as to cause the second axis (y) to rotate along with it, and consequently, to drive the main transmission element (6) passing through said at least one sprocket (1) and through said at least one chainring (3), and in that the second transmission means (13) associated with the other pedal (8) are also associated with a sprocket (14) mounted so as to rotate around the third axis (z) during the rotation of the pedal (8), and with a sprocket (12) rotatably mounted around the second axis (y) so that the pedals (7, 8) are rotationally synchronized and so that the actuation of the pedal (8) also results in the actuation of the main transmission element (6).

5. Transmission system for a cycle with two identical standard wheels according to any of claims 1 through 4, characterized in that the three axes (x, y and z), at a distance from each other, are substantially disposed in a single plane formed by two left and right parts of the rear fork of the cycle, each of said fork parts extending from the ends of the axle part constituting the first axis (x) to the ends of the axle part constituting the second axis (y).

6. Transmission system for a cycle with two identical standard wheels according to any of claims 1 through 4, characterized in that two stays (4, 5) extend parallel to each other from the ends of the axle part constituting the first axis (x) to the ends of the axle part constituting the second axis (y), each stay (4, 5) respectively being provided with a stay (5a, 5a) running transverse to each stay (4, 5), preferably perpendicular to said stays (4, 5), and at the end of which the free end of a crank (7a, 8a) supporting a pedal (7, 8) is rotatably mounted around the third axis (z).

7. Transmission system for a cycle with two identical standard wheels according to any of claims 1 through 6, characterized in that it also includes a tension sprocket (15) rotatably mounted around a fourth axis parallel to the axes (x, y and z) and making it possible to adjust the tension of the main transmission element.

8. Transmission system for a cycle with two identical standard wheels according to claim 2, characterized in that the diameter of the chainring (3) is larger than that of the sprockets (1, 10 and 11).

9. Transmission system for a cycle with two identical standard wheels according to claim 4, characterized in that the two sprockets (11, 13) rotatably mounted around the third axis (z) are of larger diameter than the sprocket (1) attached to the hub (2) and are also of larger diameter than the sprockets (10, 12) of the chainring (3).

10. Transmission system for a cycle with two identical standard wheels according to claim 3, characterized in that the sprocket (16) coaxial with the sprocket (11) is of larger diameter than the sprocket (10) of the chainring (3) and of larger diameter than the sprocket (1) attached to the hub 2.

11. Transmission system for a cycle with two identical standard wheels according to any of claims 1 through 10, characterized in that the main transmission element (6) and the first and second transmission means (9, 13) are constituted by chains or notched belts or the like, for example Kevlar belts, and the teeth of the sprockets are arranged accordingly.

12. Two-wheeled cycle of the type comprising a frame to which are attached wheels of at least 22 inches in diameter, a set of handlebars, and a saddle, characterized in that it includes a transmission system according to any of claims 1 through 11.

13. Two-wheeled cycle according to claim 12, characterized in that its frame is made to fold in half.
